(19) United States
(12) Patent Application Publication
(10) Pub. No.: US 2010/0285417 A1
(43) Pub. Date: Nov. 11, 2010

(54) System For Securing Intraoral Objects And Related Oral Structures

(76) Inventor: Russell B. Walther, Dallas, TX (US)

Correspondence Address: Gagnon, Peacock & Shanklin, P.C., 4245 N. Central Expressway, Suite 250, LB104, Dallas, TX, 75205, US

(21) Appl. No.: 12/772,418

(22) Filed: May 3, 2010

Related U.S. Application Data
(60) Provisional application No. 61/175,755, filed on May 5, 2009.

(51) Int. Cl. A61C 7/00

(52) U.S. Cl. 433/2

(57) ABSTRACT

The present disclosure provides for a system for securing intraoral objects and related oral structures during a dental procedure, the system includes a predetermined length of wire having a first end portion and a second end portion; and a first sleeve defining a cavity for slidably engaging the first end portion of the wire therein wherein the engagement of the first sleeve to the wire enhances the strength of the wire without reducing the malleability thereof and increases the safety of a dental professional and patient during the dental procedure. The system may further include a second sleeve having a cavity for slidably engaging the second end portion of the wire therein.

### CROSS-REFERENCE TO RELATED APPLICATIONS

Applicant claims priority to U.S. Provisional Patent Application No. 61/175,755, filed May 5, 2009, the disclosure of which is incorporated by reference herein in its entirety.

### DESCRIPTION OF THE DRAWINGS

FIG. 1 is a perspective exploded view of a wire and a sleeve that attaches thereto comprising an embodiment of the present invention;

FIG. 2 is side view of the wire with the sleeve attached thereto;

FIG. 3 is a side view of a dental procedure wherein the wire with attached sleeve is use to secure an arch bar to teeth;

FIG. 4 is a top view of FIG. 3;

FIG. 5 is a side view of the sleeve;

FIG. 6 is a side view of the wire with a first sleeve attached to a first end portion thereof and a second sleeve attached to a second end portion thereof comprising an embodiment of the present invention;

FIG. 7 is a side view of a wire having a variable cross-sectional area wherein the cross-sectional area of the wire incrementally increase longitudinally from a middle portion to an end portion thereof comprising an embodiment of the present invention; and

FIG. 8 is a side view of a wire having a variable cross-sectional area wherein the cross-sectional area of the wire incrementally increases longitudinally from a middle portion to a first end portion thereof and to a second end portion thereof comprising an embodiment of the present invention.

### DETAILED DESCRIPTION

Dentistry is the known evaluation, diagnosis, prevention and treatment of diseases, disorders and conditions of the soft and hard tissues of the mandible, oral cavity, maxillofacial area and the adjacent and associated structures of the human body. More specifically, it concerns the treatment of disease and malformations of the teeth, gums and oral cavity, and the renewal, correction and replacement of decayed, damaged or lost portions thereof. The practice of dentistry includes many specialized areas such as orthodontic, endodontics, periodontics, prosthodontics, pedodontics and oral surgery.

Integral to the practice of dentistry and in particular to orthodontics and oral surgery is the ability to stabilize and secure an intraoral object and/or oral appendage such as but not limited to a tooth, arch bar, arch wire, brace or appliance. Additionally in a dental procedure, stabilization of the maxilla and/or mandible during reduction or fixation of fractured facial bones may become necessary. Conventional practice involves utilizing a predetermined length of monofilament wire to stabilize and secure the intraoral object, oral appendage or related oral structures such as the mandible or maxilla.

For example, stabilization during reduction or fixation of fractured facial bones involving the teeth or maxillo-mandibular injuries includes the securing of each individual tooth to a splint or support bar shaped to an appropriate arch form. To that end, monofilament wire is cut to a relatively short, predetermined length using wire cutters or a like instrument, and then the wire is passed around the circumference of the tooth in a process known as circumdental wiring. During this process, one end of the wire is pushed through the interproximal space between the teeth at or below the gum line. The wire is positioned around the tooth and is fastened to the splint or support bar, thereby providing stabilization.

The process of cutting monofilament wire to a predetermined length, methodically circumdental wiring a tooth, and fastening the wire to a splint or support bar is widely used in the field of dentistry. Because the wire must partially conform to a tooth's circumference, readily allow its ends to be tightly twisted, and continuously retain the twist thereby holding an oral appliance in place, it must be soft and malleable. Therefore, the wire's properties must exhibit pliability but with a small degree of firmness to retain a twist. Utilizing such a wire has several disadvantages when performing dental procedures.

For instance, interdental gingiva is often penetrated during the procedure, thus causing unnecessary trauma to gum tissue. Because the wire is soft and the wire's tip is often blunt due to interaction with wire cutters or a like instrument, extra force must be exerted on the wire to properly position the wire through the interproximal space between the teeth and around the circumference of the tooth. As a result, accidental gingival penetration often results.

Also, when passing the wire gingivally to the tooth contacts, the wire is frequently impeded by gingival tissue and bone, bending it. When such high resistance is encountered, the wire's strength is inadequate to resist buckling under the pressure of the force required to push it through the gum tissue. The unintentional bending of the wire renders it useless for placing arch bars or the like, and a new segment of wire must be obtained and used, slowing the process.

Additionally, occupational exposure can occur. Surgeons frequently double or triple glove during the placement of the wire in the oral cavity due to the high risk of the procedure. Significant deflection of the wire can occur as the wire passes through tissues of various densities, thereby causing the end of the wire to exit the tissue at a location different than anticipated. As a result of this unanticipated exit location, both surgeon and patient are at a considerably higher risk of blood exposure due to the surgeon's increased risk of puncture.

Embodiments of the present invention provide advantages to both surgeon and patient by permitting easier placement of the wire during dental procedures such as in circumdental wiring, enhancing the ability of the wire to penetrate the gingiva or like tissue, when required, without significant wire buckling or bending, increasing the speed of the dental procedure in which intraoral objects, oral appendages or appliances are secured, and increasing the safety to both surgeon and patient during dental procedures. By increasing the strength and/or cross-sectional area and/or definition of the end portions of the wire, the aforementioned advantages can be realized. Other advantages will become apparent to a person of ordinary skill in this art upon a study of the following description and associated drawings.

Among the many embodiments of the present invention, one embodiment comprises a sleeve that engages with an end portion of a wire such as a filament wire, monofilament wire or the like. The sleeve slidably engages the wire by fitting over an end portion of the wire; however, the sleeve can engage the wire by various other means known to those persons of ordinary skill in the art such as but not limited to attaching, locking, mounting, joining, latching, adhering, etc. At its tip, the sleeve may form a sharp definition such as a sharp beveled edge, thereby enhancing the wire's ability to penetrate bone, gingiva or other similar tissue, when required, without significant bending. By utilizing the sleeve with the wire, the wire exhibits additional strength without sacrificing its malleable properties that are important for dental procedures.

Another embodiment employs a sleeve engaged at each end portion of the wire. Therefore, a first sleeve engages the wire at one end portion and a second sleeve engages the wire at the other end portion. A wire having a sleeve attached to each of its end portions provides additional flexibility for the dental professional and aids in enhancing safety and increasing procedural speed.

A further embodiment of the present invention comprises a wire having a variable cross-sectional area. The wire can be a filament wire, monofilament wire or the like, and the wire's end portion can comprise a substantially sharp definition to more easily penetrate tissue. According to this embodiment, the cross-sectional area of one end portion of the wire is larger than the cross-sectional area of the middle portion of the wire. Because of the wire's larger cross-sectional area at its end portion, the wire possesses additional strength without sacrificing its malleable properties. Also because the wire's end portion is larger than its middle portion, safety is maximized since fewer occupational hazards will occur such as blood exposure due to wire puncture. A wire's end portion having a larger cross-sectional area is easier to orally maneuver and locate.

An additional embodiment comprises a wire having a variable cross-sectional area wherein both end portions of the wire have a larger cross-sectional area than the wire's middle portion. This embodiment provides additional flexibility for the dental professional and aids in enhancing safety and increasing procedural speed.

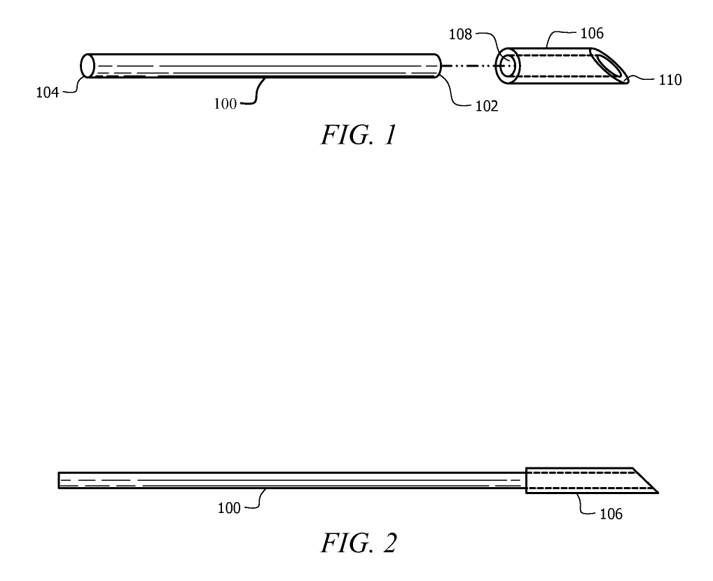

For a better understanding of the many embodiments of the present invention, drawings have been included. Turning to FIG. 1, a wire 100 is depicted having a first end portion 102 and a second end portion 104. The wire 100 usually is cut to a predetermined length using wire cutters or a like instrument. The wire 100 can be of a type that is commonly used in the field of dentistry such as but not limited to a filament wire or monofilament wire. The properties of wire 100 include that which is commonly used in the field of dentistry such as but not limited to stainless steel, metal, plastic, polymer, etc.

A sleeve 106 slidably engages the wire 100 at the first end portion 102. The properties of the sleeve 106 include that which is commonly used in the field of dentistry such as but not limited to stainless steel, metal, plastic, polymer, etc.

The sleeve 106 defines a cavity 108 for the insertion of the first end portion 102 of the wire 100. As such, the first end portion 102 of the wire 100 fits into the cavity 108 of the sleeve 106. The cavity 108 of the sleeve 106 extends longitudinally from one end thereof to the other end thereof. Therefore, the sleeve 106 is hollow.

While the embodiment in FIG. 1 illustrates that the sleeve 106 slidably engages the first end portion 102 of the wire 100, a person of ordinary skill in the art will appreciate that the sleeve 106 can engage the wire 100 in many other additional ways. For example, the sleeve 106 can engage the wire 100 by attaching, locking, mounting, joining, latching, adhering, etc.

The tip 110 of the sleeve 106 can form a sharp beveled edge as depicted in FIG. 1. During dental procedures such as in circumdental wiring, a sharp definition of the tip 110 can enhance the ability of the wire 100 to penetrate bone, gingiva or other similar tissue without significant bending.

FIG. 2 illustrates the sleeve 106 engaged with the wire 100. The wire 100 has been inserted into the cavity 108 of the sleeve 106. As such, the sleeve 106 and wire 100 are fastened together and are ready for use in a dental procedure.

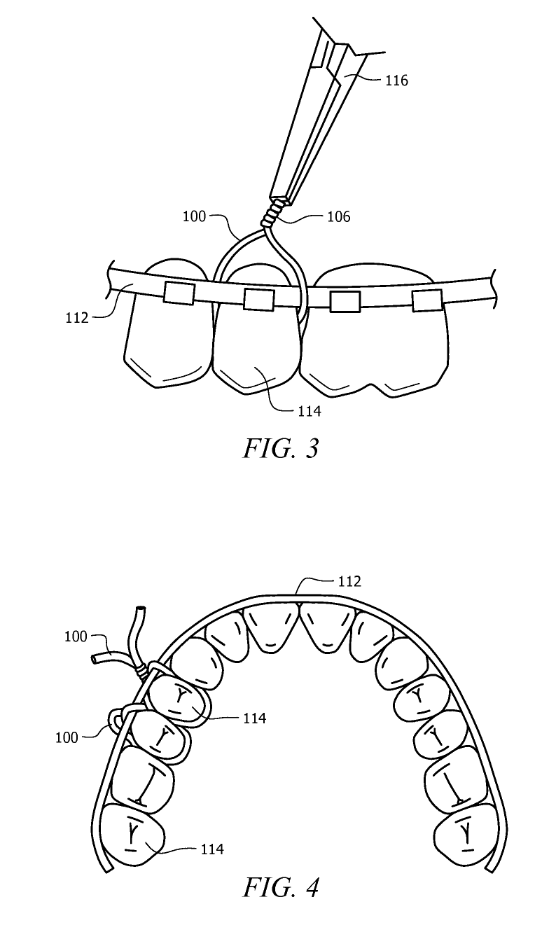

FIGS. 3 and 4 illustrate a use of the wire 100 with the sleeve 106 attached thereto during an oral placement of an arch bar 112. The wire 100 is passed gingivally to the contacts of the teeth 114. After the wire 100 is positioned correctly, a wire twister 116 is used to tightly twist the wire 100, thereby securing the arch bar 112 to the teeth 114.

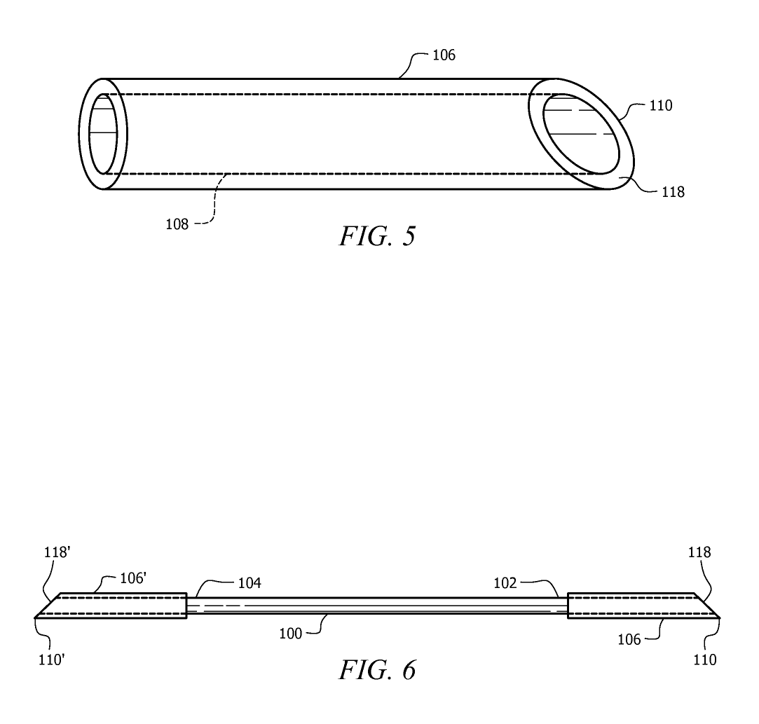

FIG. 5 depicts the sleeve 106. The sleeve 106 defines the cavity 108 for the insertion of the wire 100 therein and, therefore, is hollow. The tip 110 of the sleeve 106 can form a beveled edge 118 as depicted in FIG. 5.

As illustrated in FIG. 6, another embodiment of the present invention includes two sleeves attached to the wire. As shown, a first sleeve 106 is attached to the first end portion 102 of the wire 100 and a second sleeve 106′ is attached to the second end portion 104 of the wire 100. Each sleeve 106, 106′ slidably engages the wire 100; however, a person of ordinary skill in the art will appreciate that each sleeve 106, 106′ can engage the wire 100 in many other additional ways such as by attaching, locking, mounting, joining, latching, adhering, etc. The tip 110, 110′ of each sleeve 106 can form a sharp beveled edge 118, 118′ as depicted in FIG. 6.

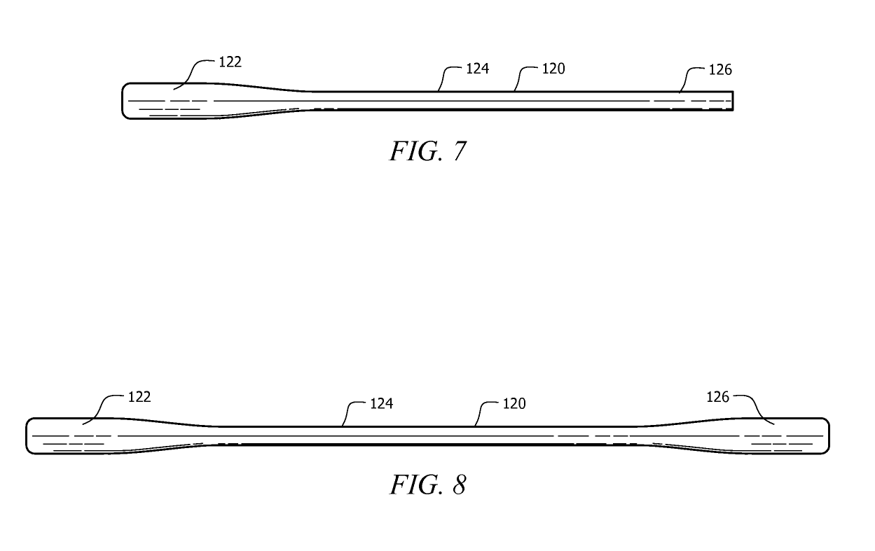

As illustrated in FIG. 7, a further embodiment of the present invention includes a wire having a variable cross-sectional area. As shown, a wire 120 comprises a first end portion 122, a middle portion 124, and a second end portion 126. The first end portion 122 comprises a larger cross-sectional area than either the middle portion 124 or the second end portion 126. The cross-sectional area of the wire 120 incrementally increases longitudinally from the middle portion 124 to the first end portion 122. Because of the larger cross-sectional area of the first end portion 122, the wire 120 possesses additional strength without sacrificing its malleable properties, thereby increasing safety and procedural speed.

The wire 120 comprises the same properties as the wire of the previous embodiments of the present invention disclosed above. Additionally, the tip of the first end portion 122 may include a beveled edge.

FIG. 8 illustrates an additional embodiment of the present invention. Similar to the embodiment illustrated in FIG. 7, the wire 120 comprises the first end portion 122, middle portion 124, and second end portion 126. However, the first end portion 122 and the second end portion 126 comprise a larger cross-sectional area than the middle portion 124. The cross-sectional area of the wire 120 incrementally increases longitudinally from the middle portion 124 to the first end portion 122 and from the middle portion 124 to the second end portion 126. Because of the larger cross-sectional area of the first end portion 122 and of the second end portion 126, the wire 120 possesses additional strength without sacrificing its malleable properties, thereby increasing safety and procedural speed. Additionally, the tip of the first end portion 122 and the tip of the second end portion 126 may include a beveled edge.

The embodiments of the present invention apply to wires, regardless of type, function or properties, sleeves, regardless of type, function, or properties, and dental procedures, regardless of type, method or function.

Although the embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

What is claimed is:

1. A system for securing intraoral objects and related oral structures during a dental procedure, the system comprising:
a predetermined length of wire having a first end portion and a second end portion; and
a first sleeve defining a cavity for slidably engaging the first end portion of the wire therein wherein the engagement of the first sleeve with the wire enhances the strength of the wire without reducing the malleability thereof and increases the safety of a dental professional and patient during the dental procedure.

2. The system for securing intraoral objects and related oral structures during a dental procedure of claim 1 wherein the wire is monofilament.

3. The system for securing intraoral objects and related oral structures during a dental procedure of claim 1 wherein the first sleeve comprises a sharp definition at the tip thereof.

4. The system for securing intraoral objects and related oral structures during a dental procedure of claim 3 wherein the sharp definition of the tip forms a beveled edge.

5. The system for securing intraoral objects and related oral structures during a dental procedure of claim 4 further comprising a second sleeve defining a cavity for slidably engaging the second end portion of the wire therein wherein the engagement of the second sleeve with the wire enhances the strength of the wire without reducing the malleability thereof and increases the safety of a dental professional and patient during the dental procedure.

6. The system for securing intraoral objects and related oral structures during a dental procedure of claim 5 wherein the second sleeve comprises a sharp definition at the tip thereof.

7. The system for securing intraoral objects and related oral structures during a dental procedure of claim 6 wherein the sharp definition of the tip forms a beveled edge.

8. A system for securing intraoral objects and related oral structures during a dental procedure, the system comprising:
a predetermined length of wire having a first end portion, a middle portion, and a second end portion wherein the cross-sectional area of the wire incrementally increases longitudinally from the middle portion to the first end portion thereof thereby enhancing the strength of the wire without reducing the malleability thereof and increasing the safety of a dental professional and patient during the dental procedure.

9. The system for securing intraoral objects and related oral structures during a dental procedure of claim 8 wherein the wire is monofilament.

10. The system for securing intraoral objects and related oral structures during a dental procedure of claim 8 wherein the first end portion of the wire comprises a sharp definition at the tip thereof.

11. The system for securing intraoral objects and related oral structures during a dental procedure of claim 10 wherein the sharp definition of the tip forms a beveled edge.

12. The system for securing intraoral objects and related oral structures during a dental procedure of claim 11 wherein the cross-sectional area of the wire incrementally increases longitudinally from the middle portion to the second end portion thereby enhancing the strength of the wire without reducing the malleability thereof and increasing the safety of a dental professional and patient during the dental procedure.

13. The system for securing intraoral objects and related oral structures during a dental procedure of claim 12 wherein the second end portion of the wire comprises a sharp definition at the tip thereof.

14. The system for securing intraoral objects and related oral structures during a dental procedure of claim 13 wherein the sharp definition of the tip forms a beveled edge.

15. A system for securing intraoral objects and related oral structures during a dental procedure, the system comprising:
a predetermined length of wire having a first end portion and a second end portion;
a first sleeve; and
a means for attaching the first sleeve to the first end portion of the wire thereby enhancing the strength of the wire without reducing the malleability thereof and increasing the safety of a dental professional and patient during the dental procedure.

16. The system for securing intraoral objects and related oral structures during a dental procedure of claim 15 wherein the first end portion of the wire comprises a sharp definition at the tip thereof.

17. The system for securing intraoral objects and related oral structures during a dental procedure of claim 16 wherein the sharp definition of the tip forms a beveled edge.

18. The system for securing intraoral objects and related oral structures during a dental procedure of claim 15 further comprising:
a second sleeve; and
a means for attaching the second sleeve to the second end portion of the wire thereby enhancing the strength of the wire without reducing the malleability thereof and increasing the safety of a dental professional and patient during the dental procedure.

19. The system for securing intraoral objects and related oral structures during a dental procedure of claim 18 wherein the second end portion of the wire comprises a sharp definition at the tip thereof.

20. The system for securing intraoral objects and related oral structures during a dental procedure of claim 19 wherein the sharp definition of the tip forms a beveled edge.
